(19) United States
(12) Patent Application Publication
(10) Pub. No.: US 2010/0131993 A1
(43) Pub. Date: May 27, 2010

(54) Method and apparatus for the efficient generation, storage and delivery of multiple versions of a video

(76) Inventors: Paul A. Sanitate, Lakewood, NJ (US); John H. Shamilian, Tinton Falls, NJ (US)

Correspondence Address: Alcatel-Lucent USA Inc.;Docket Administrator, Room 2F-192, 600 Mountain Avenue, Murray Hill, NJ, 07974-0636, US

(21) Appl. No.: 12/313,733

(22) Filed: Nov. 24, 2008

(51) Int. Cl. H04N 7/173; H04N 5/00

(52) U.S. Cl. 725/91; 386/125; 386/E05.068

(57) ABSTRACT

Multiple versions of a video such as a movie are generated, stored and delivered to a user by generating and storing a single “master” version of the video in combination with one or more lists of editing information (“edit lists”) which are used to modify the “master” version to create “alternate” versions thereof. This editing information may be based on timestamp information associated with the master version of the video or other such indexing information, and specifies a set of modifications (e.g., edits) that are to be made to the master version of the video at the specified timestamps (or indices) in order to create the desired “alternate” version of the video. Then, these edits are advantageously made to the master version of the video in real time when the video is being delivered to the user, based on the version of the video which is to be delivered.

### FIELD OF THE INVENTION

The present invention relates generally to the field of delivering video streams such as movies, and more particularly to a method and apparatus for providing highly efficient generation and storage of multiple versions of a video on a video storage media or in a video server and the delivery thereof to a user.

### BACKGROUND OF THE INVENTION

DVDs (Digital Video Discs), Blu-Ray (high definition) video discs, and streaming videos from video servers (which may, for example, be employed by cable, satellite or Internet-Protocol Television, or IPTV, providers), are typically limited to providing only a single version of a given video (e.g., a movie). However, motion picture ratings systems (such as, for example, the film ratings system promulgated in the United States by the Motion Picture Association of America) are commonly employed to classify the appropriate audience for publicly available movies, and quite often, multiple versions of such movies having different ratings are generated by (for example) the movie studios that create such movies. For example, in the United States, there are frequently as many as three (or more) versions of many popular movies—an “R” (Restricted) rated version originally shown in theaters; an “unrated” version providing additional material which was originally filmed but cut from the theatrical release (which is generally made available for video rental purposes); and a “PG” (Parental Guidance) rated version which removes portions of the material from the theatrical release (which is generally made available for use on, inter alia, commercial broadcast television and on airplanes).

However, despite the plurality of available versions, the DVDs and Blu-Ray discs which store such movies typically have only one such version stored thereon, since there is insufficient storage space available on most DVDs and Blu-Ray discs for more than one copy of most movies (except, possibly, very short ones). Similarly, video servers which store such movies typically have only one such version stored thereon, since such video servers (such as those employed by IPTV providers), which need to hold, in most cases, hundreds or even thousands of movies, also cannot afford to provide storage space for multiple copies of each movie. Even when space is available for multiple versions of a movie, storage limitations almost always will dictate that no more than two such versions may be stored.

### SUMMARY OF THE INVENTION

We have recognized that multiple versions of a video such as a movie may be advantageously generated, stored and delivered to a user by generating and storing a single (i.e., “master”) version of the video in combination with one or more lists of editing information (e.g., an “edit list”) which may be advantageously used to modify the single stored “master” version to create “alternate” versions thereof. This editing information may, for example, be based on timestamp information associated with the master version of the video or other such indexing information, and advantageously specifies a set of modifications (e.g., edits) that are to be made to the master version of the video at the specified timestamps (or indices) in order to create the desired “alternate” version of the video. Then, in accordance with one illustrative embodiment of the present invention, these edits may be advantageously made to the master version of the video in real time when the video is being delivered to the user, based on the particular version of the video which is to be delivered (e.g., the version of the video which has been requested).

More specifically, in accordance with one illustrative embodiment of the present invention, a method and apparatus is provided for generating and storing multiple versions of a video for subsequent use in delivery of selected versions of the video to a user, the method and apparatus comprising steps or program code for generating a master version of the video; generating one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof; and storing the master version of the video and the one or more edit lists for said subsequent use in said delivery of said selected versions of the video to the user.

In addition, in accordance with another illustrative embodiment of the present invention, a method and apparatus is provided for delivering a selected one of multiple versions of a video to a user, the method and apparatus comprising steps or program code for retrieving a master version of the video and one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof; modifying the master version of the video based on the selection of said one of said multiple versions of the video to be delivered to the user and on the one or more edit lists, to generate the selected one of the multiple versions of the video; and delivering the selected one of the multiple versions of the video to the user.

And in accordance with another illustrative embodiment of the present invention, a digital storage medium for use in delivery of a selected one of multiple versions of a video to a user is provided, the digital storage medium having stored thereon a master version of the video; and one or more edit lists, each edit list comprising one or more specified modifications to be made to the master version of the video based on a selection of the selected one of said multiple versions of the video, each of said modifications being specified as one or more locations in said master version of the video and one or more changes to be made to the master version of the video at said one or more locations thereof.

### BRIEF DESCRIPTION OF THE DRAWINGS

FIG. 1 shows a flowchart of an illustrative method for generating a master version of a video for use in a system for generating multiple versions of the video in accordance with an illustrative embodiment of the present invention.

FIG. 2 shows a flowchart of an illustrative method for generating an alternate version of a video for use in a system for generating multiple versions of the video in accordance with an illustrative embodiment of the present invention.

FIG. 3 shows a flowchart of an illustrative method for delivering a selected one of multiple versions of a video in accordance with an illustrative embodiment of the present invention.

### DETAILED DESCRIPTION OF THE PREFERRED EMBODIMENTS

In accordance with the principles of the present invention, a master version of a video (such as, for example, a movie) is advantageously generated along with one or more “edit lists” which specify modifications which are to be made to the master version of the video to generate a selected “alternate” version of the video. These modifications may, in accordance with certain illustrative embodiments of the present invention, be based on timestamp information associated with the master version of the video or other such indexing information (such as, for example, video frame numbers, which would provide the maximum possible resolution), and may advantageously specify a set of modifications (e.g., edits) that are to be made to the master version of the video at the specified timestamps (or indices) in order to create the desired “alternate” version of the video. Then, in accordance with one illustrative embodiment of the present invention, these edits may be advantageously made to the master version of the video in real time when the video is being delivered to the user, based on the particular version of the video which is to be delivered (e.g., the version of the video which has been requested).

In accordance with certain illustrative embodiments of the present invention, multiple versions of a video may be advantageously stored on a video disc such as a DVD or Blu-Ray disc. (The general term “video disc” as used herein is intended to include DVDs, Blu-Ray discs, and discs of any other format, either presently defined or to be defined in the future, that may be distributed with video content thereon.) That is, both the master version of the video and at least one edit list (and, possibly, in accordance with some of these illustrative embodiments, one or more extra footage files—see discussion below), may be advantageously stored on the video disc. Then, in accordance with one illustrative embodiment of the present invention, the edits to create the desired (e.g., selected) version of the video may be advantageously made in real time by the video disc player (e.g., a DVD player or a Blu-Ray player) which is being used to play back (the selected version of) the video.

In accordance with other illustrative embodiments of the present invention, only the master version of the video is stored on a video disc such as a DVD or Blu-Ray disc. Then, in accordance with these illustrative embodiments of the present invention, the video disc player which is being used to play back (the selected version of) the video, which is advantageously provided with Internet access capability, may advantageously check a predetermined Internet website to retrieve edit information from one or more edit files accessible therefrom. If such is edit information is found, then the video disc player may advantageously apply the appropriate edits to the master version of the video in order to deliver the selected version of the video to the user.

In accordance with other illustrative embodiments of the present invention, multiple versions of a video are advantageously stored in a video server for use in, for example, an IPTV or other “video-on-demand” video streaming environment, which may, for example, be delivered to a user's set-top box. Then, in accordance with one illustrative embodiment of the present invention, the edits to create the desired (e.g., selected) version of the video may be advantageously applied in real time by the video server itself. In this manner, there will advantageously be no interruption in the stream of video to the user's set-top box.

In addition, in accordance with still other illustrative embodiments of the present invention, multiple versions of a video may be delivered based on a master version which is broadcast. In accordance with these illustrative embodiments of the present invention, the broadcast video may be recorded to an enhanced DVR (Digital Video Recorder) device, which then advantageously applies the appropriate edits, based on one or more edit lists, to the master version of the video in real time, to thereby create the desired alternate version of the video for delivery to the user. In accordance with some of these illustrative embodiments of the present invention, the edit lists may be stored locally in the enhanced DVR itself, whereas in accordance with other ones of these illustrative embodiments of the present invention, the edit information may be retrieved from the Internet, as is described above (in connection with a video disc player having Internet access capability).

In accordance with certain illustrative embodiments of the present invention, the “master” version of the video may be advantageously generated in an essentially conventional manner, using, for example, a standard non-linear editing station using conventional “authoring” software or other standard industry systems (referred to generally as “authoring systems”). Such authoring systems are fully familiar to those of ordinary skill in the art.

In accordance with certain illustrative embodiments of the present invention, however, one or more “alternate” versions of the video may be advantageously generated, after the generation of the “master” version thereof, by using a novel authoring system designed in accordance with the principles of the present invention. In particular, the illustrative authoring system which may be employed to generate an alternate version of the video in accordance with an illustrative embodiment of the present invention, rather than generating a full video stream of the alternate version (as is done by conventional authoring systems which are used to generate multiple versions of a video), advantageously generates at least one “edit list” which specifies one or more modifications to be made to the master version in order to produce the given alternate version. As such, the resultant alternate version, in accordance with the principles of the present invention, is comprised of (at least) the master version along with the edit list (or edit lists, if more than one such edit list is associated with the given alternate version).

In accordance with various illustrative embodiments of the present invention, there may be a separate edit list (or set of edit lists) for each alternate version of the video, or there may be one (or more than one) edit list which specifies a plurality of sets of modifications to be made to the master video corresponding to a plurality of alternate versions of the video. Moreover, in accordance with various illustrative embodiments of the present invention, one or more “extra footage” files may also be generated by the illustrative authoring system, whereby one or more of the modifications to the master version specified in one (or more) of the edit lists specifies that one or more portions of the master version is to be replaced with alternate video content (or alternate audio content), or that certain alternate video content (or alternate audio content) is to be inserted at a given location in the master video. In such a case, such alternate video content (or alternate audio content) may be advantageously incorporated in an extra footage file. Note that in accordance with these illustrative embodiments of the present invention, the resultant alternate version is advantageously comprised of (at least) the master version along with the edit list (or edit lists, if more than one such edit list is associated with the given alternate version) and one or more extra footage files.

The editing information may, for example, be based on timestamp information associated with the master version of the video or other such indexing information, and may advantageously specify a set of modifications (e.g., edits) that are to be made to the master version of the video at the specified timestamps (or indices) in order to create the desired “alternate” version of the video. Then, in accordance with one illustrative embodiment of the present invention, these edits may be advantageously made to the master version of the video in real time when the video is being delivered to the user, based on the particular version of the video which is to be delivered (e.g., the version of the video which has been requested).

In accordance with various illustrative embodiments of the present invention, the modifications specified in the edit list(s) may, for example:

delete a scene (or a portion thereof) of the video;

mute a portion of the audio track of the video (which may be used, for example, in order to remove an expletive from the audio track);

replace a portion of the audio track of the video with either a “beep” or alternative audio content such as a replacement word or phrase (which may also be used, for example, in order to remove an expletive from the audio track);

replace a scene (or a portion thereof) of the master video with alternative video content;

add alternative video content at a given location in the master video; and/or

reduce the visibility of a portion of a scene (in order to hide inappropriate nudity, for example), which may be achieved, for example, either by “pixelation” of the portions to be hidden or by the insertion of “black bars” over such portions.

By way of examples only, the following listing represents possible specifications for modifications which are to be made to the master version of a video, in order to generate a particular alternate version thereof, in accordance with certain illustrative embodiments of the present invention. For example, such modifications may be specified when the master version of the video is a movie having an “R” (Restricted) rating, in order to generate an alternate version of the movie having, for example, a “PG” (Parental Guidance) rating instead. (Of course, such specifications may be advantageously encoded, rather than being expressed in natural language, for efficient representation. Techniques for performing such an encoding and a corresponding decoding will be fully obvious to those of ordinary skill in the art.) Some illustrative examples are:

1. Delete a portion of the master video (e.g., a scene) at timestamp 1:13:47, length 1:23. (That is, delete one minute and 23 seconds of the master video beginning at the one hour, 13 minute and 47 second mark of the master video. Note that timestamps and times may alternatively and advantageously be specified with a greater resolution than seconds, as is shown here. Alternatively, locations in the master video or in an extra footage file may be specified as video frame numbers, thereby providing the maximum possible resolution.)

2. Replace a portion of the master video (e.g., a scene) at timestamp 34:22, length 2:48, with footage to be found in (for example) the extra footage file at time 23:02, length 1:55. (That is, replace two minutes and 48 seconds of the master video beginning at the 34 minute and 22 second mark of the master video with the one minute and 55 seconds of replacement video that can be found in the extra footage file at the 23 minute and 2 second mark.)

3. Insert (additional) alternate video into the master video at timestamp 34:22, with footage to be found in (for example) the extra footage file at time 23:02, length 1:55. (That is, insert one minute and 55 seconds of alternate video that can be found in the extra footage file at the 23 minute and 2 second mark into the master video at the 34 minute and 22 second mark thereof.)

4. Replace a portion of the audio track of the master video at timestamp 34:22, length 0:48, with alternate audio content found in (for example) the extra footage file at time 23:02, length 0:48. (That is, replace 48 seconds of the master video's audio track beginning at the 34 minute and 22 second mark of the master video with the 48 seconds of alternate audio content that can be found in the extra footage file at the 23 minute and 2 second mark.)

5. Pixelate a portion of the master video at timestamp 23:32, length 0:05, with a pixelation rectangle at pixel location (34,57) and size of (12,13) pixels. (That is, each video frame of the master video, beginning at the 23 minute and 32 second mark of the master video and ending 5 seconds later, should be pixelated with a pixelation rectangle with its upper left corner located in the frame at pixel coordinates (34,57) and having a width of 12 pixels and a height of 13 pixels.)

6. “Black bar out” a portion of the master video at timestamp 23:32, length 0:05, with an overlaid black rectangle at pixel location (34,57) and size of (12,13) pixels. (That is, each video frame of the master video, beginning at the 23 minute and 32 second mark and ending 5 seconds later, should be overlaid with a black rectangle with its upper left corner located in the frame at pixel coordinates (34,57) and having a width of 12 pixels and a height of 13 pixels.)

7. Mute a portion of the audio track of the master video at timestamp 34:22, length 0:48. (That is, mute 48 seconds of the master video's audio track beginning at the 34 minute and 22 second mark of the master video for 48 seconds.)

8. “Beep out” a portion of the audio track of the master video at timestamp 34:22, length 0:48. (That is, overdub 48 seconds of the master video's audio track with a “beep” beginning at the 34 minute and 22 second mark of the master video for 48 seconds.)

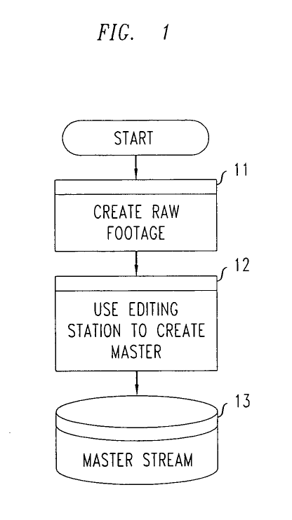

FIG. 1 shows a flowchart of an illustrative method for generating a master version of a video for use in a system for generating multiple versions of the video in accordance with an illustrative embodiment of the present invention. The illustrative method, which is similar in operation to that of a conventional authoring system, first creates the raw footage (block 11), and then uses an editing station (which may or may not be conventional) to create a master version of the video from the raw footage (block 12). This advantageously produces master stream file 13 (i.e., the master version of the video).

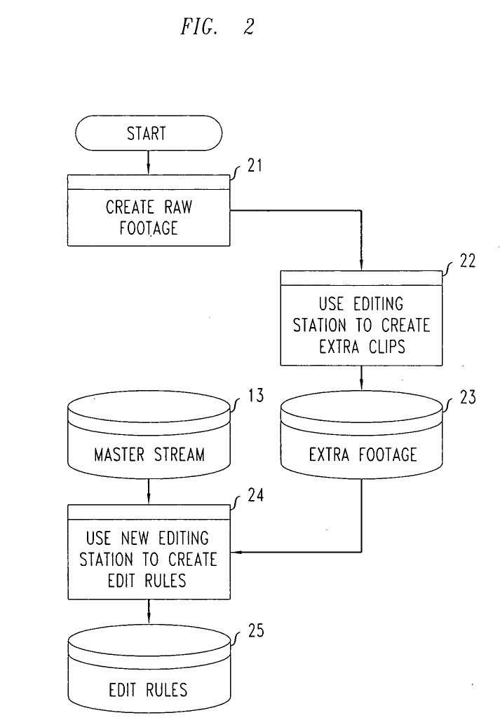

FIG. 2 shows a flowchart of an illustrative method for generating an alternate version of a video for use in a system for generating multiple versions of the video in accordance with an illustrative embodiment of the present invention. First, if extra footage is needed for the given alternate version, any extra raw footage which will be used therein is created (block 21). Then (again, if extra footage is needed), an editing station (which may or may not be conventional) is used (in block 22) to create extra footage file 23 from the raw footage. Next, in accordance with the principles of the present invention, master stream file 13 (i.e., the master version of the video, as illustratively generated by the method of FIG. 1) is used (in block 24), together with extra footage file 23 (if it has been created), by a novel editing station in accordance with an illustrative embodiment of the present invention, to create edit rules file 25. In particular, edit rules file 25 is created based on the desired content of the given alternate version of the video (e.g., by determining the changes which would need to be made to the master version of the video in order to produce the alternate version of the video). It is this edit rules file, together with the master version of the video (i.e., master stream file 13), and also (if it has been created) extra footage file 23, that in combination make up the alternate version of the video.

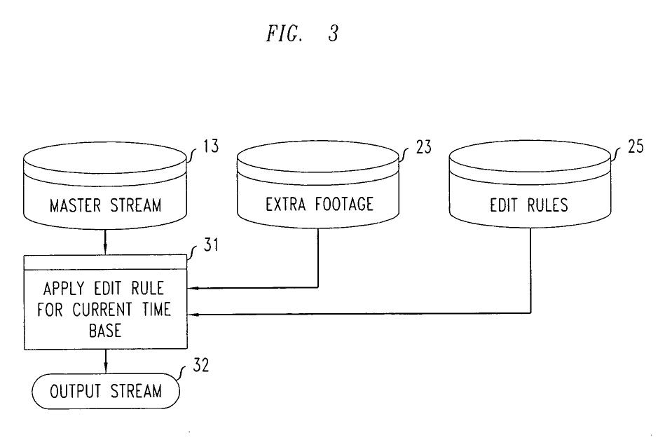

FIG. 3 shows a flowchart of an illustrative method for delivering a selected one of multiple versions of a video in accordance with an illustrative embodiment of the present invention. The illustrative method makes use of master stream file 13 and edit rules file 25, as well as extra footage file 23 (if extra footage is needed for the selected version of the video). Using these files, the master version of the video is streamed sequentially (from master stream file 13), and edit rules (as retrieved from edit rules file 25) are applied sequentially to the master stream at the current time base (in block 31) to produce output stream 32. Extra footage which is needed based on the edit rules is retrieved from extra footage file 23 (if extra footage is needed for the selected version of the video). In accordance with various illustrative embodiments of the present invention, output stream 32 as produced by the illustrative method of FIG. 3 may be provided directly to the user via a video disc player (e.g., a DVD player or a Blu-Ray player in the case of DVD or Blu-Ray discs) or via a set-top box (e.g., in the case of video-on-demand), or it may be stored and then output to the user (e.g., by a Digital Video Recorder).

In accordance with certain illustrative embodiments of the present invention, a digital storage medium is provided which has stored thereon a master version of the video and one or more edit lists (as described above). In accordance with some of these illustrative embodiments, the digital storage medium may comprise a video disc such as a DVD or a Blu-Ray disc. In accordance with other ones of these illustrative embodiments, the digital storage medium may comprise a video server. And in accordance with some of these illustrative embodiments, the digital storage medium may further have stored thereon one or more extra footage files.

In addition, in accordance with certain illustrative embodiments of the present invention, a master version of the video may be advantageously stored as an encoded video signal, which may, for example, be encoded in accordance with a video coding standard, and the delivery of the video to the user may include decoding the encoded version of the stored master version of the video, also in accordance with the video coding standard. (Note, for example, that video discs such as DVDs and Blu-Ray discs typically store video content in such an encoded format in accordance with a video coding standard.) Also, alternate video content which may, for example, be stored in the above-described extra footage files may also be advantageously stored as encoded video signals which may, for example, be encoded in accordance with a video coding standard. As will be fully understood by one of ordinary skill in the art, when the master video and/or the extra footage files are stored as encoded video signals, certain limitations may exist as to which locations within the video signals may have modifications begun thereat. For example, in certain conventional video coders based on video frame “prediction” (which coders are fully familiar to those of ordinary skill in the art), it may be necessary to begin modifications to the video stream at “intra-coded” (non-predicted) frames only. Techniques for ensuring that such restrictions are adhered to will be fully obvious to those of ordinary skill in the art.

Also, in accordance with various illustrative embodiments of the present invention, illustrative systems may be advantageously implemented using machine-executable code which implement the principles of the present invention. For example, the above-described illustrative methods may be physically embodied in machine-executable code which may then be incorporated into a conventional (or unconventional) memory device, and such executable code may then be executed by a conventional (or unconventional) associated processor. As used herein, the term “memory” is used without limitation and may comprise any type of data storage device which may hold machine-executable code (which may comprise software, firmware, microcode, etc.), including, for example, read-only memory (ROM), random access memory (RAM), mass storage devices (such as, for example, a disc), etc. Similarly, as used herein, the term “processor” is used without limitation and may comprise any device capable of executing program code, including software, firmware, microcode, etc., which is supplied thereto in any possible manner. For example, in accordance with certain illustrative embodiments of the present invention, the processor and memory may be devices incorporated into a video disc player (e.g., a DVD player or a Blu-Ray player).

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, although the above description of the illustrative embodiments are focused specifically on movies, and the alternative versions of such movies are generally assumed herein to be differently rated versions thereof, one of ordinary skill in the art will appreciate that the principles of the present invention may be similarly applied to any video streams having multiple possible versions thereof employed for any reason or purpose whatsoever.

In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for generating and storing multiple versions of a video for subsequent use in delivery of selected versions of the video to a user, the method comprising the steps of:
generating a master version of the video;
generating one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof; and
storing the master version of the video and the one or more edit lists for said subsequent use in said delivery of said selected versions of the video to the user.

2. The method of claim 1 wherein the step of storing the master version of the video and the one or more edit lists comprises storing the master version of the video and the one or more edit lists together on a video disc.

3. The method of claim 1 wherein the step of storing the master version of the video and the one or more edit lists comprises storing the master version of the video and the one or more edit lists together in a video server.

4. The method of claim 1 wherein said locations in said master version of the video are specified as timestamps therein.

5. The method of claim 1 wherein the modifications to be made to the master version of the video which are specified in the one or more edit lists comprise one or more of:
deleting one or more portions of the master version of the video;
muting one or more portions of an audio track of the master version of the video;
replacing one or more portions of the audio track of the master version of the video with alternate audio content;
replacing one or more portions of the master version of the video with alternate video content;
inserting alternate video content into the master version at a specified location; and
modifying one or more portions of the master version of the video by reducing the visibility of one or more portions thereof.

6. The method of claim 1 further comprising the step of generating one or more extra footage files which comprise alternate video content referenced by said one or more edit lists as one of said modifications to be made to said master version of the video.

7. A method for delivering a selected one of multiple versions of a video to a user, the method comprising the steps of:
retrieving a master version of the video and one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof;
modifying the master version of the video based on the selection of said one of said multiple versions of the video to be delivered to the user and on the one or more edit lists, to generate the selected one of the multiple versions of the video; and
delivering the selected one of the multiple versions of the video to the user.

8. The method of claim 7 wherein the master version of the video and the one or more edit lists are retrieved from a video disc, and wherein the method is performed by a video disc player.

9. The method of claim 7 wherein the master version of the video and the one or more edit lists are retrieved from a video server.

10. The method of claim 7 wherein said locations in said master version of the video are specified as timestamps therein.

11. The method of claim 7 wherein the modifications to be made to the master version of the video which are specified in the one or more edit lists comprise one or more of:
deleting one or more portions of the master version of the video;
muting one or more portions of an audio track of the master version of the video;
replacing one or more portions of the audio track of the master version of the video with alternate audio content;
replacing one or more portions of the master version of the video with alternate video content;
inserting alternate video content into the master version at a specified location; and
modifying one or more portions of the master version of the video by reducing the visibility of one or more portions thereof.

12. The method of claim 7 further comprising the step of retrieving one or more extra footage files which comprise alternate video content referenced by said one or more edit lists as one of said modifications to be made to said master version of the video, and wherein the step of modifying the master version of the video is further based on said one or more extra footage files.

13. An apparatus for generating and storing multiple versions of a video for subsequent use in delivery of selected versions of the video to a user, the apparatus comprising a processor and a memory, the memory comprising machine-executable code which, when executed by the processor:
generates a master version of the video;
generates one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof; and
stores the master version of the video and the one or more edit lists for said subsequent use in said delivery of said selected versions of the video to the user.

14. The apparatus of claim 13 wherein the master version of the video and the one or more edit lists are stored together on a video disc.

15. The apparatus of claim 13 wherein the master version of the video and the one or more edit lists are stored together in a video server.

16. The apparatus of claim 13 wherein said locations in said master version of the video are specified as timestamps therein.

17. The apparatus of claim 13 wherein the modifications to be made to the master version of the video which are specified in the one or more edit lists comprise one or more of:
deleting one or more portions of the master version of the video;
muting one or more portions of an audio track of the master version of the video;
replacing one or more portions of the audio track of the master version of the video with alternate audio content;
replacing one or more portions of the master version of the video with alternate video content;
inserting alternate video content into the master version at a specified location; and
modifying one or more portions of the master version of the video by reducing the visibility of one or more portions thereof.

18. The apparatus of claim 13 wherein the machine-executable code, which, when executed by the processor, further generates one or more extra footage files which comprise alternate video content referenced by said one or more edit lists as one of said modifications to be made to said master version of the video.

19. An apparatus for delivering a selected one of multiple versions of a video to a user, the apparatus comprising a processor and a memory, the memory comprising machine-executable code which, when executed by the processor:
retrieves a master version of the video and one or more edit lists, each edit list comprising one or more specified modifications to be made to the master version of the video based on a selection of one of said multiple versions of the video, each of said modifications being specified as one or more locations in said master version of the video and one or more changes to be made to the master version of the video at said one or more locations thereof;
modifies the master version of the video based on the selection of said one of said multiple versions of the video to be delivered to the user and on the one or more edit lists, to generate the selected one of the multiple versions of the video; and
delivers the selected one of the multiple versions of the video to the user.

20. The apparatus of claim 19 wherein the master version of the video and the one or more edit lists are retrieved from a video disc, and wherein the apparatus comprises a video disc player.

21. The apparatus of claim 19 wherein the master version of the video and the one or more edit lists are retrieved from a video server.

22. The apparatus of claim 19 wherein said locations in said master version of the video are specified as timestamps therein.

23. The apparatus of claim 19 wherein the modifications to be made to the master version of the video which are specified in the one or more edit lists comprise one or more of:
deleting one or more portions of the master version of the video;
muting one or more portions of an audio track of the master version of the video;
replacing one or more portions of the audio track of the master version of the video with alternate audio content;
replacing one or more portions of the master version of the video with alternate video content;
inserting alternate video content into the master version at a specified location; and
modifying one or more portions of the master version of the video by reducing the visibility of one or more portions thereof.

24. The apparatus of claim 19 wherein the machine-executable code, which, when executed by the processor, further retrieves one or more extra footage files which comprise alternate video content referenced by said one or more edit lists as one of said modifications to be made to said master version of the video, and wherein the modifying of the master version of the video is further based on said one or more extra footage files.

25. A digital storage medium for use in delivery of a selected one of multiple versions of a video to a user, the digital storage medium having stored thereon:
a master version of the video; and
one or more edit lists, each edit list comprising one or more specified modifications to be made to the master version of the video based on a selection of the selected one of said multiple versions of the video, each of said modifications being specified as one or more locations in said master version of the video and one or more changes to be made to the master version of the video at said one or more locations thereof.

26. The digital storage medium of claim 25 wherein the digital storage medium comprises a video disc.

27. The digital storage medium of claim 25 wherein the digital storage medium comprises a video server.

28. The digital storage medium of claim 25 wherein said locations in said master version of the video are specified as timestamps therein.

29. The digital storage medium of claim 25 wherein the modifications to be made to the master version of the video which are specified in the one or more edit lists comprise one or more of:
deleting one or more portions of the master version of the video;
muting one or more portions of an audio track of the master version of the video;
replacing one or more portions of the audio track of the master version of the video with alternate audio content;
replacing one or more portions of the master version of the video with alternate video content;
inserting alternate video content into the master version at a specified location; and
modifying one or more portions of the master version of the video by reducing the visibility of one or more portions thereof.

30. The digital storage medium of claim 25, wherein the digital storage medium further has stored thereon one or more extra footage files which comprise alternate video content referenced by said one or more edit lists as one of said modifications to be made to said master version of the video.
